(19) United States
(12) Patent Application Publication
(10) Pub. No.: US 2026/0163982 A1
(43) Pub. Date: Jun. 11, 2026

(54) PRINTING INSPECTION SYSTEM

(71) Applicant: SEIKO EPSON CORPORATION, TOKYO (JP)

(72) Inventor: Shinichiro NIIYAMA, Sapporo-shi (JP)

(21) Appl. No.: 19/415,898

(22) Filed: Dec. 11, 2025

(30) Foreign Application Priority Data
Dec. 11, 2024 (JP) 2024-216215

(51) Int. Cl. H04N 1/00; H04N 1/60

(52) U.S. Cl. CPC H04N 1/00005; H04N 1/00034; H04N 1/00079; H04N 1/00915; H04N 1/6027

(57) ABSTRACT

A printing inspection system includes an acceptance portion configured to accept a print image from a first user; a printing portion configured to print the print image and a colorimetric image indicating a spot color contained in the print image; an instruction portion configured to instruct a second user to perform colorimetry on the colorimetric image; a colorimetry portion configured to acquire a result of the colorimetry performed by the second user on the colorimetric image; and a notification portion configured to notify the first user of the result of the colorimetry.

The present application is based on, and claims priority from JP Application Serial Number 2024-216215, filed Dec. 11, 2024, the disclosure of which is hereby incorporated by reference herein in its entirety.

### BACKGROUND

### 1. Technical Field

The present disclosure relates to a printing inspection system.

### 2. Related Art

There is a known color management technology of related art for matching a color printed by a printing apparatus with an intended color. As the color management technology, there is a known technology for performing colorimetry on a patch printed by a printing apparatus with a colorimeter and correcting the color based on the result of the colorimetry (JP-A-2024-033661, for example).

JP-A-2024-033661 is an example of the related art.

A print image printed by a printing apparatus contains in some cases a spot color that is a color printed by the printing apparatus and having a colorimetric value that should match with a defined value by color management. Performing colorimetry on the spot color contained in the print image allows determination of whether the spot color is appropriately printed. It is, however, difficult to determine which part of the print image contains the spot color based on printed matter printed by the printing apparatus.

### SUMMARY

A printing inspection system according to an embodiment includes an acceptance portion configured to accept a print image from a first user; a printing portion configured to print the print image and a colorimetric image indicating a spot color contained in the print image; an instruction portion configured to instruct a second user to perform colorimetry on the colorimetric image; a colorimetry portion configured to perform the colorimetry in response to the second user's work; and a notification portion configured to notify the first user of a result of the colorimetry.

### BRIEF DESCRIPTION OF THE DRAWINGS

FIG. 1 diagrammatically shows an example of a print job management system.

FIG. 2 is a block diagram showing the configuration of a server.

FIG. 3 is a block diagram showing an example of a print image.

FIG. 4 is a block diagram showing an example of a colorimetric image.

FIG. 5 is a block diagram showing the configuration of a first user terminal.

FIG. 6 is a block diagram showing the configuration of a second user terminal.

FIG. 7 is a block diagram showing the configuration of a printing apparatus.

FIG. 8 is a flowchart in accordance with which various apparatuses operate in notification of information on a print job.

FIG. 9 is a flowchart in accordance with which the apparatuses operate in the notification of information on a print job.

FIG. 10 shows the procedure of time-series printing in a case where multiple copies of the print image shown are printed.

### DESCRIPTION OF EMBODIMENTS

Embodiments of the present disclosure will be described herein in the following order:
(1) Configuration of printing inspection system:
(1-1) Configuration of server:
(1-2) Configuration of first user terminal:
(1-3) Configuration of second user terminal:
(1-4) Configuration of printing apparatus:
(2) Printing inspection:
(3) Other embodiments:

### (1) Configuration of Printing Inspection System

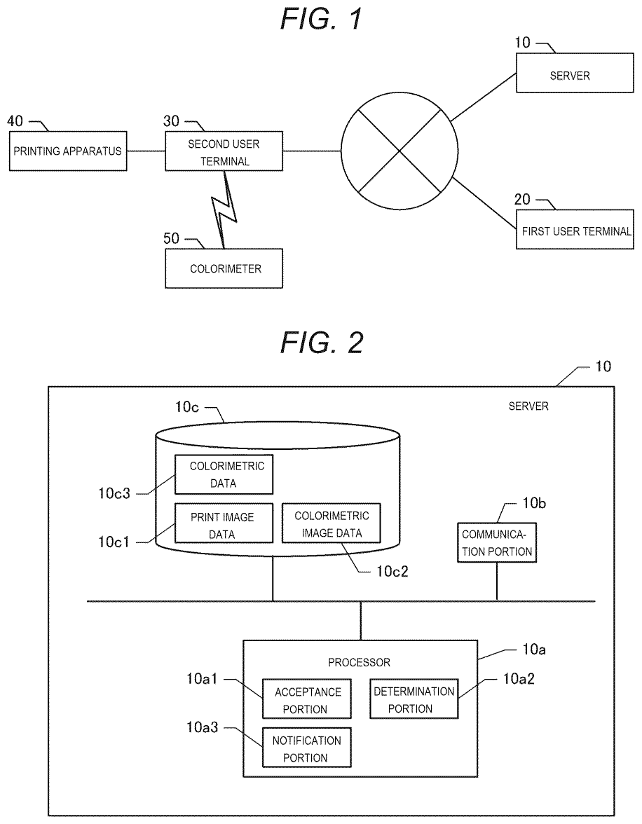

FIG. 1 diagrammatically shows an example of the configuration of a printing inspection system including a server according to an embodiment of the present disclosure. The printing inspection system includes a server 10, a first user terminal 20, a second user terminal 30, a printing apparatus 40, and a colorimeter 50. In the present embodiment, the printing apparatus 40 and the colorimeter 50 are coupled to the second user terminal 30. A first user can use the first user terminal 20 to upload print image data indicating a print image to the server 10 and cause the printing apparatus 40 to print the print image. A second user is a user who performs work relating to the printing apparatus 40, and uses the second user terminal 30 to manage the printing performed by the printing apparatus 40, measure a colorimetric value with the colorimeter 50, and perform other operations. In the present embodiment, the number of each of the apparatuses shown in FIG. 1 is an example, and is not limited to a specific value.

In the present embodiment, the server 10, the first user terminal 20, and the second user terminal 30 can communicate with each other via a network. The network may have any of various aspects, and may be a local network, or the apparatuses present at physically separate places may communicate with each other via the Internet or any other network. The printing apparatus 40 and the colorimeter 50 may be directly capable of communicating with the server 10 and the first user terminal 20. In the present embodiment, the system including the server 10 is a system that prints printed matter, and another process, for example, surface treatment may be further performed on the printed mater printed by the system.

In the present embodiment, the first user prepares a print image indicating a print image to be printed, and causes the printing apparatus 40 present at a remote location to print the print image. The first user prepares the print image data indicating the print image and registers the print image data in the server 10. The first user sets print conditions, image quality in printing operation, the number of copies to be printed, and other factors relating to the print image data to generate a print job. When the print job is generated, the server 10 instructs the second user terminal 30 to perform printing. The second user terminal 30 generates print data by performing predetermined processing based on the print image data, and transmits the print data to the printing apparatus 40. The printing apparatus 40 performs printing based on the print data.

In the present embodiment, the print image printed by the first user contains a spot color to be printed in a correct color. The spot color is a color that needs to be printed in a planned color. However, since the first user is not at the location where the printing apparatus 40 is installed, it is difficult to determine whether the spot color is an appropriate color in the result of the printing.

Since the printing apparatus 40 is installed at a location where the second user can manage the printing apparatus 40, the second user can pick up the printed matter. The second user can accurately measure the color of the printed matter with the colorimeter 50, but the second user cannot determine which portion of the printed matter has the spot color by visually recognizing the printed matter. In view of the fact described above, the present embodiment is so configured that the second user can identify a portion to be subjected to colorimetry by using the printed matter. In the present embodiment, information indicating whether the spot color has been printed in an appropriate color can be provided to the first user. The apparatuses that constitute the thus configured printing inspection system will be described below.

### (1-1) Configuration of Server

FIG. 2 is a block diagram showing the configuration of the server 10. The server 10 includes a processor 10a, a communication portion 10b, and a storage medium 10c. The processor 10a includes a CPU, a ROM, a RAM, and other elements none of which is shown, and can execute various programs recorded in the storage medium 10c to control the portions of the server 10 and the apparatuses connected to the network. Note that the processor 10a may be configured with a single chip, may be configured with multiple chips, or may be configured as an SoC along with various functional blocks that operates the portions. For example, an ASIC may be employed in place of the CPU, or the CPU and the ASIC may cooperate with each other. When the apparatuses in the present embodiment each include a processor, the processor can be implemented in various aspects, as the processor 10a.

The communication portion 10b includes a communication interface via which the communication portion 10b communicates with an external instrument in accordance with various wired or wireless communication protocols. The server 10 can communicate with the other apparatuses via the communication portion 10b. Note that the communication portion 10b may include an interface via which the communication portion 10b communicates with various removable memories incorporated in the server 10.

Various pieces of information are accumulated in the storage medium 10c of the server 10. For example, print image data 10c1, colorimetric image data 10c2, and colorimetric data 10c3 are saved in the storage medium 10c. The print image data 10c1 is data indicating an image to be printed by the first user. In the present embodiment, the print image data 10c1 contains a spot color and colors other than the spot color. That is, the print image data 10c1 contains information indicating a print target such as a character or an image to be printed, and contains information indicating the color of each print target. The spot color is a color that is specified so as to be printed in a specific color, and the color of each pixel is specified by a gradation value in an instrument-independent color space, for example, a CIELAB value. The colors other than the spot color are each specified by defining a gradation value of an instrument-dependent color space, for example, a gradation value of RGB (R: red, G: green, B: blue) on a pixel basis.

The print image data 10c1 may have any format, and may be configured, for example, with a PDF file. The print image data 10c1 also contains data indicating the print job that prints the print image. That is, the print image data 10c1 contains the print conditions under which the print image is printed. The print conditions are conditions under which the print image is printed, and may include any condition such as image quality in printing operation, a printing speed, colors used in printing, the number of copies to be printed, and the type of print medium. In the present embodiment, the print image data 10c1 further contains information indicating the degree of importance of the print image. The degree of importance is an index indicating the importance of spot color management, and a higher degree of importance requires a smaller color difference between the colorimetric value of the spot color and the CIELAB value indicating the spot color. A higher degree of importance further requires a higher (better) yield. That is, a higher degree of importance requires that whether the spot color is an appropriate color is checked more frequently.

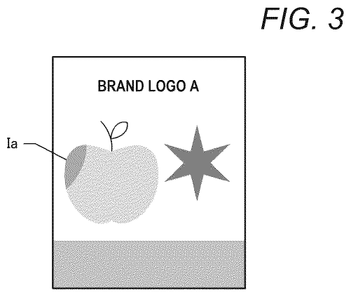

FIG. 3 shows an example of the print image defined by the print image data 10c1. In the print image shown in FIG. 3, an upper portion of a print medium contains a brand logo A expressed by characters, and a middle portion of the print medium contains pictures of an apple and a star. A lower portion of the print image contains a band-shaped pattern. It is assumed in the description that the brand logo A and an apple portion Ia have the spot color.

The colorimetric image data 10c2 is data indicating a colorimetric image indicating the spot color contained in the print image. That is, an image produced by extracting only the spot color portions from the print image is the colorimetric image. In the present embodiment, the colorimetric image data 10c2 is data in which the CIELAB value indicating the spot color is associated with the pixels that constitute the spot color portions. The colorimetric image data 10c2 may have any format, and may, for example, be a PDF file showing an image drawn only with the spot color.

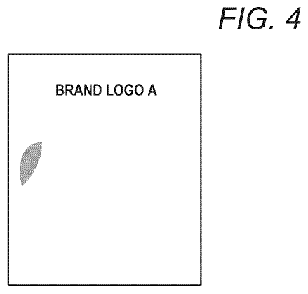

Note that the colorimetric image data 10c2 also contains data used to print the colorimetric image, and that the printing conditions other than the number of copies to be printed are the same as those contained in the print image data 10c1. Although the number of copies to be printed is not specified, the second user terminal 30 prints the colorimetric image the number of which is smaller than the number of copies of the print image. FIG. 4 shows an example of the colorimetric image defined by the colorimetric image data 10c2. The colorimetric image is configured only with the spot color portions contained in the print image, as shown in FIG. 4.

The colorimetric data 10c3 is data indicating the result of colorimetry performed on the spot color portions on a print medium on which the colorimetric image has been printed, and data indicating CIELAB values of the portions.

### (1-2) Configuration of First User Terminal

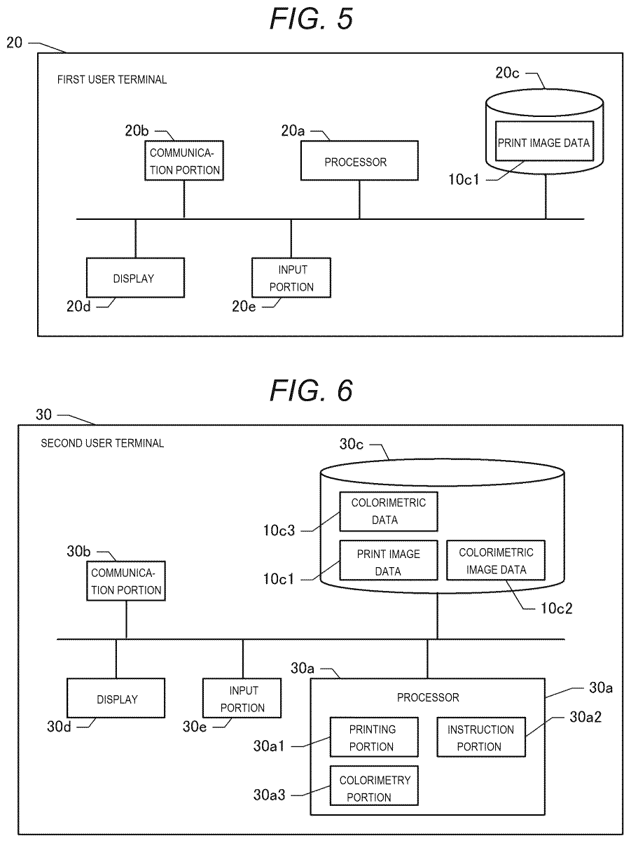

FIG. 5 is a block diagram showing the configuration of the first user terminal 20. The first user terminal 20 includes a processor 20a, a communication portion 20b, a storage medium 20c, a display 20d, and an input portion 20e. The processor 20a includes a CPU, a ROM, a RAM, and other elements none of which is shown, and can execute various programs recorded in the storage medium 20c to control the portions of the first user terminal 20.

The communication portion 20b includes a communication interface via which the communication portion 20b communicates with an external instrument in accordance with various wired or wireless communication protocols. The first user terminal 20 can communicate with the other apparatuses via the communication portion 20b. The communication portion 20b includes an interface via which the communication portion 20b communicates with various removable memories incorporated in the first user terminal 20.

The print image data 10c1 prepared by the first user is recorded in the storage medium 20c of the first user terminal 20. Portions of the print image indicated by the print image data 10c1 have the spot color. The first user generates a print job that prints the print image by uploading the print image data 10c1 to the server 10. The print image data 10c1 may be recorded in the storage medium 20c in any form. For example, the print image data 10c1 prepared by the first user may be recorded in a removable memory and transferred from the removable memory to the storage medium 20c via the communication portion 20b. The print image data 10c1 may instead be acquired from an external apparatus via the network. Still instead, the first user may use the first user terminal 20 to create the print image data 10c1 with the aid, for example, of an application program, and record the created print image data 10c1 in the storage medium 20c. The first user or other person may, of course, edit a document created by a third party to generate the print image data 10c1, and record the generated print image data 10c1 in the storage medium 20c.

The display 20d is a display apparatus that displays any image. The input portion 20e is an apparatus via which the first user performs an input operation, and includes, for example, a keyboard and a mouse or a touch panel. In any case, the first user can input the first user's intention by operating the input portion 20e while visually recognizing an image or a character displayed on the display 20d.

The first user can access the server 10 and perform various inputs by using the display 20d and the input portion 20e of the first user terminal 20 as a user interface. The inputs include an input relating to generation of the print job using the print image data 10c1, for example, inputs for setting the print conditions and the degree of importance.

### (1-3) Configuration of Second User Terminal

FIG. 6 is a block diagram showing the configuration of the second user terminal 30. The second user terminal 30 is an apparatus that generates print data that causes the printing apparatus 40 to print the print image, and print data that causes the printing apparatus 40 to print the colorimetric image, and controls the printing. The second user terminal 30 is also a terminal that controls the colorimeter 50 and acquires the result of the colorimetry performed by the colorimeter 50. In the present embodiment, it is assumed that the second user terminal 30 is a mobile terminal. The terminal used to generate the print data and the terminal used to acquire the result of the colorimetry may, of course, be different terminals. Furthermore, the present embodiment shows a case where one printing apparatus 40 is coupled to one second user terminal 30, and multiple printing apparatuses 40 may be coupled to one second user terminal 30.

The second user terminal 30 includes a processor 30a, a communication portion 30b, a storage medium 30c, a display 30d, and an input portion 30e. The processor 30a includes a CPU, a ROM, a RAM, and other elements none of which is shown, and can execute various programs recorded in the storage medium 30c to control the portions of the second user terminal 30.

The communication portion 30b includes a communication interface via which the communication portion 30b communicates with an external instrument in accordance with various wired or wireless communication protocols. The second user terminal 30 can communicate with the other apparatuses via the communication portion 30b. The communication portion 30b includes an interface via which the communication portion 30b communicates with various removable memories incorporated in the second user terminal 30.

The storage medium 30c of the second user terminal 30 saves the print image data 10c1 and the colorimetric image data 10c2 transmitted from the server 10. The processor 30a generates print data by performing predetermined processing based on the print image data 10c1 and causes the printing apparatus 40 to print the print image. The processor 30a further generates print data by performing predetermined processing based on the colorimetric image data 10c2 and causes the printing apparatus 40 to print the colorimetric image. Furthermore, when the colorimetry is performed by the colorimeter 50, the colorimetric data 10c3 indicating the result of the colorimetry is transmitted from the colorimeter 50 and saved in the storage medium 30c. Note that the colorimeter 50 is an apparatus that measures the color of any portion on any medium and outputs a color value. Various known apparatuses can be used as the colorimeter 50. In the present embodiment, the colorimeter 50 wirelessly communicates with the second user terminal 30 and outputs the colorimetric data 10c3 indicating a CIELAB value. Note in the present embodiment that it is assumed that the colorimeter 50 is a handheld colorimeter operated by the second user and is a device separate from the printing apparatus 40.

The display 30d is a display apparatus that displays any image. The input portion 30e is an apparatus via which the second user performs an input operation, and includes, for example, a keyboard and a mouse or a touch panel. Various pieces of information may be displayed on the display 30d, and the second user can perform various inputs by operating the input portion 30e.

### (1-4) Configuration of Printing Apparatus

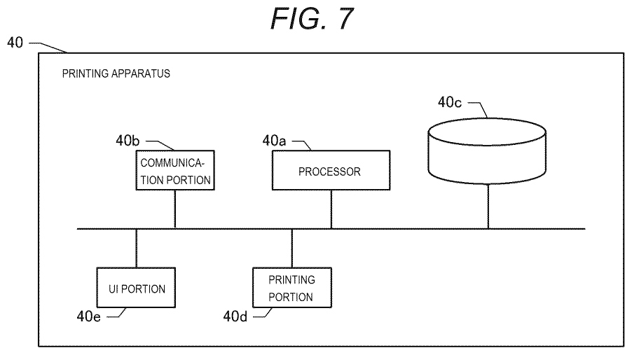

FIG. 7 is a block diagram showing the configuration of the printing apparatus 40. The printing apparatus 40 includes a processor 40a, a communication portion 40b, a storage medium 40c, a printing portion 40d, and a UI portion 40e. The processor 40a includes a CPU, a ROM, a RAM, and other elements none of which is shown, and can execute various programs recorded in the storage medium 40c to control the portions of the printing apparatus 40.

The communication portion 40b includes a communication interface via which the communication portion 40b communicates with an external instrument in accordance with various wired or wireless communication protocols. The printing apparatus 40 can communicate with the other apparatuses via the communication portion 40b. The communication portion 40b may include an interface via which the communication portion 40b communicates with various removable memories incorporated in the printing apparatus 40.

The printing portion 40d is a portion that performs printing, and various printing methods, such as an inkjet method and an electrophotographic method, may be employed. The printing portion 40d includes an actuator, various apparatuses, sensors, drive circuits, mechanical components, and the like used to perform printing on various print media. The sensors include a sensor that detects various detection targets that can change in the printing apparatus 40. The detection targets are not limited to specific ones, and examples of the sensors may include a sensor that detects the remaining amount of the print medium, and a sensor that detects the remaining amount of each color ink used to perform printing.

The UI portion 40e includes a touch panel display, various keys and switches, or the like. The touch panel display includes a display panel that displays various pieces of information, for example, the status of the printing apparatus 40 and the remaining amount of ink, and a touch detection panel superimposed on the display panel, and detects a touch operation performed, for example, with a human finger. The processor 40a can acquire the content of the operation performed by the second user via the UI portion 40e. The processor 40a can display various pieces of information on a display of the UI portion 40e to notify a user of the information. The second user may be able to instruct the start of print medium replacement, interruption of the print job, or the like via the UI portion 40e.

The processor 40a performs printing in response to an instruction from the second user terminal 30. That is, when printing according to the print job is performed, print data is delivered from the second user terminal 30 to the printing apparatus 40. The processor 40a receives the print data via the communication portion 40b, and controls the printing portion 40d to print a print content indicated by the print data.

### (2) Printing Inspection

In the print inspection system described above, the server 10, the first user terminal 20, the second user terminal 30, the printing apparatus 40, and the colorimeter 50 can cooperate with each other to inspect whether the spot color contained in the print image has been printed as an appropriate color. The printing inspection will be described below.

The processor 10a of the server 10 functions as an acceptance portion 10a1, a determination portion 10a2, and a notification portion 10a3 by executing a program that is not shown. The acceptance portion 10a1 is the function of accepting the print image from the first user. The determination portion 10a2 is the function of determining whether the result of the colorimetry satisfies a criterion. The notification portion 10a3 is the function of notifying the first user of the result of the colorimetry.

The processor 30a of the second user terminal 30 executes a program that is not shown to function as a printing portion 30a1, an instruction portion 30a2, and a colorimetry portion 30a3. The printing portion 30a1 is the function of printing the print image and the colorimetric image which indicates the spot color contained in the print image. The instruction portion 30a2 is the function of instructing the second user to perform colorimetry on the colorimetric image. The colorimetry portion 30a3 is the function of acquiring the result of the colorimetry performed on the colorimetric image by the second user.

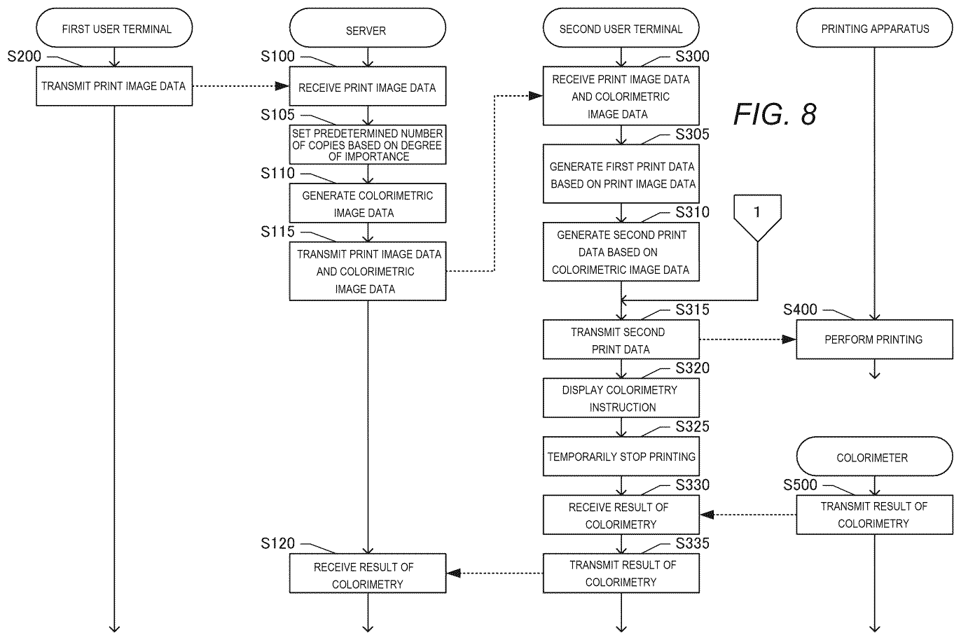

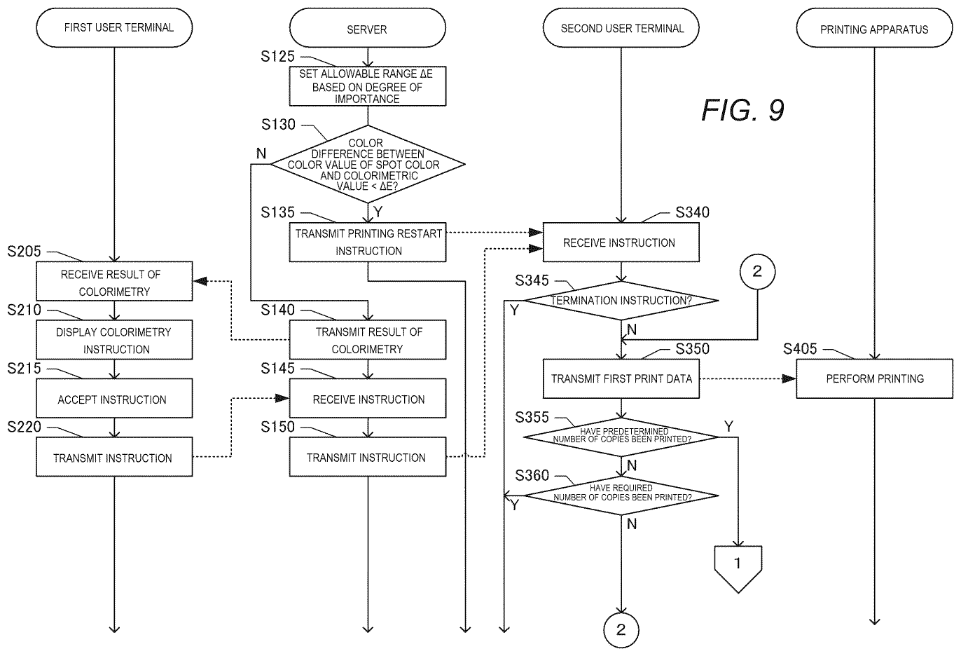

In the present embodiment, when the first user prints multiple copies of the print image, the printing inspection of whether the spot color contained in the print image is an appropriate color is performed with the aid of the functions of the processor 10a and the processor 30a. FIGS. 8 and 9 are flowcharts in accordance with which the apparatuses perform the printing inspection. The first user operates the input portion 20e of the first user terminal 20 to carry out the process of transmitting the print image data 10c1 to the server 10 (step S200).

Specifically, the first user operates the input portion 20e to specify a print file indicating the print image, and specify the printing conditions under which the print image is printed. In the present embodiment, the print file contains a layer that specifies the spot color, and the spot color is specified as a color of pixels in the layer. The spot color is specified in the form of CIELAB value. In the present embodiment, the printing conditions include a necessary number of copies that is the number of copies of the print image to be printed. The first user further specifies the degree of importance of the print image. When various types of specification relating to the print image are performed, the processor 20a generates the print image data 10c1 containing information of the various types of specification, and transmits the print image data 10c1 to the server 10 via the communication portion 20b.

The processor 10a of the server 10 receives the print image data via the communication portion 10b with the aid of the function of the acceptance portion 10a1 (step S100). That is, the processor 10 a receives the print image data 10c1 and saves the print image data 10c1 in the storage medium 10c with the aid of the function of the acceptance portion 10a1. The processor 10a having carried out the processes described above accepts the print image from the first user, accepts the printing conditions under which the print image is printed, and accepts the degree of importance of the print image with the aid of the function of the acceptance portion 10a1. A print job is generated by saving the print image data 10c1 containing the print conditions in the server 10.

The processor 10a then sets a predetermined number of copies based on the degree of importance (step S105). The predetermined number of copies is an index indicating the number of the print images per which the colorimetric image is printed. That is, in the present embodiment, the colorimetric image is printed whenever the predetermined number of copies of the print image are printed. In the present embodiment, since the second user is instructed to perform the colorimetry when the colorimetric image is printed, the predetermined number of copies can also be regarded as the number that defines how frequently the instruction of the colorimetry performed on the colorimetric image is issued. In the present embodiment, the processor 10a sets a smaller predetermined number of copies for a higher degree of importance. That is, the instruction of the colorimetry is issued more frequently when the degree of importance is high than when the degree of importance is low. The correspondence between the degree of importance and the predetermined number of copies may be determined in advance. In the present embodiment, an increase in the degree of importance causes reduction in the predetermined number of copies in a stepwise manner.

When the processor 10a receives the print image data 10c1, the processor 10 a generates the colorimetric image data 10c2 based on the print image data 10c1 (step S110). That is, the processor 10a refers to the print image data 10c1 received in step S100, extracts only the layer that specifies the spot color, and generates the colorimetric image data 10c2 used to print an image on the layer as the colorimetric image. Since the colorimetric image is an image generated by extracting the layer for the spot color contained in the print image data 10c1, the color of each pixel in the layer is the spot color and is specified by a CIELAB value. The print conditions are the same as the conditions specified in the print image data 10c1 except for a specific condition, for example, the number of copies to be printed. The generated colorimetric image data 10c2 is saved in the storage medium 10c.

The processor 10a then transmits the print image data 10c1 and the colorimetric image data 10c2 to the second user terminal 30 via the communication portion 10b (step S115). The processor 30a of the second user terminal 30 receives the print image data 10c1 and the colorimetric image data 10c2 via the communication portion 30b (step S300). The processor 30a saves the received print image data 10c1 and colorimetric image data 10c2 in the storage medium 30c.

The processor 30a then generates first print data based on the print image data 10c1 (step S305), and generates second print data based on the colorimetric image data 10c2 (step S310) with the aid of the function of the printing portion 30a1. The processor 30a can generate the two types of print data based on the two types of image data by performing various types of image processing according to the printing conditions. The print data is data in a format that allows the processor 40a of the printing apparatus 400 to perform printing. Steps S305 and S310 allow the printing apparatus 40 to print the print image and the colorimetric image.

The processor 30a then transmits the second print data to the printing apparatus 40 via the communication portion 30b with the aid of the function of the printing portion 30a1 (step S315). As a result, the printing apparatus 40 performs printing based on the second print data. That is, the printing apparatus 40 prints the colorimetric image.

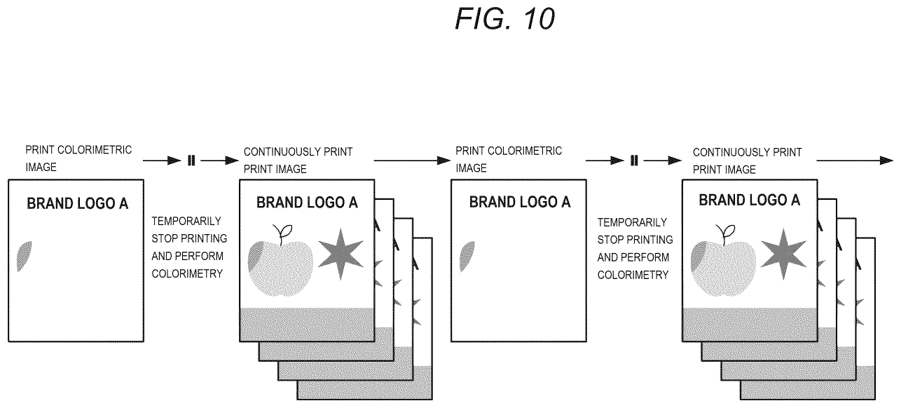

FIG. 10 shows the procedure of time-series printing in a case where multiple copies of the print image shown in FIG. 2 are printed. FIG. 10 diagrammatically shows images printed at various timings along a time course progressing from left to right. When the printing starts in the present embodiment, step S315 is first carried out, so that the colorimetric image is first printed, as shown in the leftmost part of FIG. 10.

The processor 30a then controls the display 30d to cause the display 30d to display a colorimetry instruction with the aid of the function of the instruction portion 30a2 (step S320). That is, the processor 30a prompts the second user to perform colorimetry on the result of the printing in which the printing apparatus 40 prints the colorimetric image. When the colorimetry instruction is displayed, the second user performs colorimetry on the colorimetric image with the colorimeter 50. Since only the spot color portion is printed in the colorimetric image as shown in FIGS. 4 and 10, the second user can readily recognize a portion to be subjected to the colorimetry only by visually recognizing the result of printing the colorimetric image.

When the colorimetry instruction is displayed, the processor 30a temporarily stops the printing (step S325). That is, the printing is temporarily stopped by transmitting no print data to the printing apparatus 40 but causing the printing apparatus 40 to stand by. The aspect in which the printing is temporarily stopped may, of course, be any of various aspects. When the printing apparatus 40 repeats printing multiple times based on the same print data, an instruction of temporarily stopping the printing may be transmitted from the processor 30a to the printing apparatus 40.

When the second user operates the colorimeter 50 to perform colorimetry, the colorimeter 50 transmits the result of the colorimetry (step S500). When the result of the colorimetry is transmitted, the processor 30a receives the result of the colorimetry via the communication portion 30b with the aid of the function of the colorimetry portion 30a3 (step S330). That is, the processor 30a acquires a CIELAB value produced by performing colorimetry on the result of printing the colorimetric image. When the CIELAB value is acquired, the acquired CIELAB value is saved as the colorimetric data 10c3 in the storage medium 10c. Note that when there are colorimetry target portions at multiple locations (multiple colors), a CIELAB value is associated with identification information for identifying each of the measurement targets.

The processor 30a then transmits the result of the colorimetry to the server 10 via the communication portion 30b (step S335). The processor 10a receives the result of the colorimetry via the communication portion 10b (step S120).

The processor 10a then sets an allowable range ΔE based on the degree of importance with the aid of the function of the determination portion 10a2 (step S125). The allowable range ΔE is a value indicating an allowable magnitude as a color difference between a CIELAB value that is the color value of the spot color and a CIELAB value that is the colorimetric value. In the present embodiment, the processor 10a sets a narrower allowable range ΔE when the degree of importance is high than when the degree of importance is low. The correspondence between the degree of importance and the predetermined number of copies may be determined in advance. In the present embodiment, an increase in the degree of importance causes reduction in the allowable range ΔE in a stepwise manner.

The processor 10a then determines whether the color difference between the color value of the spot color and the colorimetric value is smaller than ΔE with the aid of the function of the determination portion 10a2 (step S130). That is, the processor 10a determines whether the color difference between the result of the colorimetry and the color value of the spot color falls within the allowable range ΔE. When the determination is made by the determination portion 10a2, the processor 10a notifies the first user of information indicating the result of the determination with the aid of the function of the notification portion 10a3. In the present embodiment, however, when the result of the determination satisfies a criterion, the first user is not notified, and the printing is continued. On the other hand, when the result of the determination does not satisfy the criterion, the first user is notified of the information.

Specifically, when it is determined that the color difference between the result of the colorimetry and the color value of the spot color is smaller than the allowable range ΔE, the processor 10a transmits a printing restart instruction to the second user terminal 30 via the communication portion 10b (step S135). The processor 30a of the second user terminal 30 receives the instruction via the communication portion 30b (step S340). The processor 30a determines whether the received instruction is a printing termination instruction (step S345). When the print restart instruction in step S135 is received, the processor 30a does not determine in step S345 that the received instruction is the printing termination instruction because the instruction is not the printing termination instruction.

In this case, the processor 30a transmits the first print data to the printing apparatus 40 with the aid of the function of the printing portion 30a1 (step S350). As a result, the printing apparatus 40 performs printing based on the first print data (step S405). That is, the printing apparatus 40 prints the print image. In the example shown in FIG. 10, after the colorimetric image is first printed, the printing is temporarily stopped in order for the second user to perform colorimetry with the colorimeter 50. When the colorimetry performed by the second user shows that the color difference between the color value of the spot color and the colorimetric value is smaller than ΔE, the printing is restarted in step S350, and the print image is printed. According to the configuration described above, when the result of the colorimetry satisfies the criterion, the printing can be continued without bothering the first user.

The processor 30a then determines with the aid of the function of the printing portion 30a1 whether the predetermined number of copies of the print image have been printed (step S355). That is, when the number of copies in which the number of copies of the continuously printed print image coincides with the predetermined number of copies after the colorimetric image is last printed in steps S315 and S400, the processor 30a determines that the predetermined number of copies of the print image have been printed.

When it is not determined in step S355 that the predetermined number of copies of the print image have been printed, the processor 30a determines with the aid of the function of the printing portion 30a1 whether the required number of copies of the print image have been printed (step S360). That is, the processor 30a determines whether the total number of copies of the printed print image coincides with the required number of copies set by the first user.

when it is determined in step S360 that the required number of copies of the print image have been printed, the processor 30a terminates the series of processes of printing the print image and waits for the next print instruction. On the other hand, when it is not determined in step S360 that the required number of copies of the print image have been printed, the processor 30a repeats the processes in step S350 and the subsequent steps. That is, the processor 30a repeats printing the print image. As a result, the print images are continuously printed, as shown in FIG. 10.

On the other hand, when it is determined in step S355 that the predetermined number of copies of the print image have been printed, the processor 30a repeats the processes in step S315 and the subsequent steps. That is, the processor 30a prints the colorimetric image again and carries out the process of inspecting whether the spot color is appropriate.

In step S130 described above, when it is not determined that the color difference between the color value of the spot color and the colorimetric value is smaller than ΔE, that is, when the color difference between the result of the colorimetry and the color value of the spot color exceeds the allowable range ΔE, so that the result of the colorimetry does not satisfy the criterion, the processor 10a transmits the result of the colorimetry with the aid of the function of the notification portion 10a3 (step S140). The result of the colorimetry, which is information to be transmitted, only needs to be information that causes the first user to recognize the result of the colorimetry. In the present embodiment, the result of the colorimetry contains the CIELAB value of the spot color, a CIELAB value as a result of the colorimetry performed on the spot color, and information indicating that the color difference between the two CIELAB values is greater than ΔE. The processor 10a transmits these pieces of information to the first user terminal 20 via the communication portion 10b.

According to the processes described above, the processor 10a notifies the first user of the result of the colorimetry when the color difference is greater than or equal to the allowable range ΔE, and does not notify the first user of the result of the colorimetry when the color difference is smaller than the allowable range ΔE with the aid of the function of the notification portion 10a3. It can also be said that the configuration in which the first user is notified of the result of the colorimetry when the color difference is greater than or equal to the allowable range ΔE is a configuration in which the first user is notified of the determination result indicating that the result of the colorimetry does not satisfy the criterion.

When the result of the colorimetry is transmitted, the processor 20a of the first user terminal 20 receives the result of the colorimetry with the aid of the function of the communication portion 20b (step S205), and displays the result of the colorimetry (step S210). That is, the processor 20a controls the display 20d to cause the display 20d to display the result of the colorimetry. In the present embodiment, information indicating that the CIELAB value of the spot color, the CIELAB value as a result of the colorimetry performed on the spot color, and the information indicating that the color difference between the two CIELAB values is greater than ΔE is displayed on the display 20d. The first user can therefore recognize that the spot color has not been printed as an appropriate color. Furthermore, whether the color difference is acceptable can also be determined based on the CIELAB value of the spot color and the CIELAB value as a result of the colorimetry performed on the spot color.

The first user operates the input portion 20e to input an instruction indicating whether to terminate the printing based on the result of the colorimetry. The processor 20a accepts the instruction (step S215), and transmits information indicating the content of the instruction to the server 10 (step S220). The processor 10a of the server 10 receives the instruction via the communication portion 10b (step S145), and transmits the instruction to the second user terminal (step S150).

When the instruction is transmitted, the processor 30a of the second user terminal 30 receives the instruction (step S340), and determines whether the instruction is a termination instruction (step S345). That is, when the first user instructs termination of the printing, the processor 30a determines that it is instructed to terminate the printing in step S345, exits from the loop configured with steps S315 to S355, and terminates the printing. When the first user instructs continuation of the printing, the processor 30a carries out the processes in step S350 and the subsequent steps. According to the processes described above, even when the first user cannot confirm the printed medium at hand, the first user can determine whether the spot color is an appropriate color and determine whether to terminate the printing.

### (3) Other Embodiments

The embodiment described above is an example in which the present disclosure is implemented, and a variety of other embodiments can be employed. For example, in the embodiment described above, the server 10 and the first user terminal 20 are configured with different apparatuses, but the same apparatus may serve as both the server 10 and the first user terminal 20, or the functions of the server 10 and the first user terminal 20 may be allocated to three or more apparatuses in a distributed manner. At least two of the second user terminal 30, the printing apparatus 40, and the colorimeter 50 may be integrated into a single unit. Furthermore, the order in which the processes in FIGS. 8 and 9 are carried out is not limited to the order shown in the two figures.

For example, the order in which the continuously displayed processes, such as steps S200 and S205, and S115 and S120 in FIGS. 8 and 9, are carried out may be changed, and the processes may each be carried out at any timing and may not be executed continuously. In the example shown in FIGS. 8 and 9, the colorimetric image is first printed, and the print image is then continuously printed. However, the first colorimetric image may not be printed, but the print image may be continuously printed from the beginning, and the colorimetric image may be printed after the predetermined number of copies are printed.

Furthermore, when the first user is notified that the color difference is out of the allowable range, there may be an option other than terminating the printing. For example, the first user may instruct cleaning and adjusting the printing apparatus 40, performing color management, or any other operation.

The acceptance portion only needs to accept the print image from the first user. That is, the acceptance portion only needs to generate a print job that prints the print image based on an instruction from the first user. The print job may contain a print file indicating the print image, and various pieces of information other than the print conditions, for example, information indicating a delivery date, a delivery destination, the first user, the second user, and other parameters.

The printing portion only needs to print the print image and the colorimetric image indicating the spot color contained in the print image. That is, the printing portion prints the print image, which is an image to be printed. The printing portion further prints the colorimetric image indicating the spot color contained in the print image.

The print image indicates a print content intended by the first user to be printed by the printing portion, and the print content may be identified by the first user uploading the print file as described above, or may be a content generated by the first user using various application programs.

The colorimetric image only needs to be an image indicating the spot color contained in the print image, and only needs to be an image in which the spot color contained in the print image is printed. The colorimetric image is therefore, unlike the embodiment described above, not limited to the print image from which an image having colors other than the spot color is removed. For example, the colorimetric image may be a patch drawn in the spot color, or the print image which is reduced in size and from which an image having colors other than the spot color is removed. The colorimetric image may instead be an image indicating the position or any other factor of a spot color portion contained in the print image.

The number of times the colorimetric image is printed in the process of continuously printing multiple copies of the same print image is not limited to a specific value. For example, the colorimetric image may be printed at regular intervals, or the colorimetric image may be printed once, the position of a spot color portion to be subjected to colorimetry may be identified based on the colorimetric image at the colorimetry timing, and the position of the spot color portion in the print image may be measured.

The instruction portion only needs to instruct the second user to perform colorimetry on the colorimetric image. That is, the instruction portion may cause the second user who performs colorimetry to recognize that colorimetry should be performed on the colorimetric image. For example, in the continuous printing process, the instruction may be issued at a timing at which the colorimetry should be performed, or in the continuous printing process, the instruction may be issued when a condition determined in advance as a condition under which the color to be printed changes by a predetermined amount is satisfied.

As the condition determined in advance, various criteria can be employed, for example, a certain number of sheets or more have been printed, the number of times a nozzle used to print the spot color exceeds a default number of times, the amount of ink ejected via the nozzle used to print the spot color exceeds a default amount, and a difference in the number of times between multiple nozzles used to print the spot color exceeds a default criterion. The instruction portion may cause any apparatus, for example, the server, the printing apparatus, an information processing apparatus, or the colorimeter to output the instruction. The instruction may be output in any form, for example, in the form of display, sound, or any other output.

The colorimetry portion only needs to acquire a result of the colorimetry performed on the colorimetric image by the second user. That is, the colorimetry portion only needs to acquire a result of the colorimetry performed by the second user operating the colorimeter on printed matter on which the colorimetric image has been printed. The result of the colorimetry is information indicating the color of the colorimetric image, and only needs to indicate a colorimetric value in an instrument-independent color space. The instrument-independent color space is, of course, not limited to the CIELAB color space, and may be any of various color spaces.

The notification portion only needs to notify the first user of the result of the colorimetry. That is, the notification portion only needs to notify the first user, who is a user different from the second user and who has generated the print image, of the result of the colorimetry provided by the second user's work. As a result, the first user only needs to see the result of the colorimetry even when the first user has not performed the colorimetry by himself/herself.

The determination portion only needs to determine whether the result of the colorimetry satisfies the criterion. That is, the determination portion only needs to determine whether the spot color has been appropriately printed. The criterion used to evaluate the result of the colorimetry only needs to be a criterion used to determine whether the spot color is an appropriate color, and may, for example, be a criterion used to evaluate the color difference between the color value of the spot color, that is, the color value of the spot color in an instrument-independent color space, and the colorimetric value, for example, the allowable range described above.

Furthermore, the acceptance portion may be able to accept, from the first user, information on a criterion used to determine whether the result of the colorimetry satisfies the criterion. That is, the first user may be able to input information on a criterion used to evaluate the result of the determination in addition to the degree of importance. In this case, the criterion is determined based on the first user's input. For example, information indicating the allowable range of the color difference may be input from the first user. According to the configuration described above, the first user can determine the criterion used to determine whether the spot color is appropriate.

Furthermore, the instruction portion may instruct the second user to perform colorimetry on the colorimetric image by causing the printing portion to temporarily stop printing multiple copies of the print image. For example, the second user may recognize that the colorimetry is necessary by seeing the situation in which the operation of displaying the colorimetry instruction in step S320 is omitted, and the colorimetric image is printed in steps S315 and S400, so that the printing is temporarily stopped. The configuration described above, which is a simple configuration, can give the colorimetry instruction to the second user.

The present disclosure is further applicable to a program and a method executed by a computer. The system, the program, and the method described above are implemented in some cases as a single apparatus, or are implemented in other cases by using components provided in multiple apparatuses, and include various aspects. The system can be changed as appropriate, for example, configured to be partly software and partly hardware. The present disclosure is further implemented as a recording medium that stores a program that controls the system. The recording medium that stores the program may, of course, be a magnetic recording medium or a semiconductor memory, and any recording medium to be developed in the future can be taken in the same manner.

What is claimed is:

1. A printing inspection system comprising:
an acceptance portion configured to accept a print image from a first user;
a printing portion configured to print the print image and a colorimetric image indicating a spot color contained in the print image;
an instruction portion configured to instruct a second user to perform colorimetry on the colorimetric image;
a colorimetry portion configured to acquire a result of the colorimetry performed by the second user on the colorimetric image; and
a notification portion configured to notify the first user of the result of the colorimetry.

2. The printing inspection system according to claim 1, wherein
the acceptance portion is configured to accept information on a degree of importance of the print image from the first user, and
the instruction portion is configured to instruct the colorimetry more frequently when the degree of importance is high than when the degree of importance is low.

3. The printing inspection system according to claim 1, further comprising
a determination portion configured to determine whether the result of the colorimetry satisfies a criterion,
wherein the notification portion is configured to notify the first user of information indicating a result of the determination made by the determination portion.

4. The printing inspection system according to claim 1, further comprising
a determination portion configured to determine whether a color difference between the result of the colorimetry and a color value of the spot color falls within an allowable range,
wherein the notification portion is configured to notify the first user of the result of the colorimetry when the color difference is outside the allowable range, and not to notify of the first user the result of the colorimetry when the color difference falls within the allowable range.

5. The printing inspection system according to claim 4, wherein
the acceptance portion is configured to accept information on a degree of importance of the print image from the first user, and
the determination portion is configured to make the allowable range narrower when the degree of importance is high than when the degree of importance is low.

6. The printing inspection system according to claim 3, wherein
the acceptance portion is configured to accept information on the criterion from the first user.

7. The printing inspection system according to claim 1, wherein
the instruction portion is configured to instruct the second user to perform the colorimetry on the colorimetric image by causing the printing portion to temporarily stop printing multiple copies of the print image.

8. The printing inspection system according to claim 7, further comprising
a determination portion configured to determine whether the result of the colorimetry satisfies a criterion,
wherein the printing portion is configured to restart the printing when the result of the colorimetry satisfies the criterion.

9. The printing inspection system according to claim 7, further comprising
a determination portion configured to determine whether the result of the colorimetry satisfies a criterion,
wherein the acceptance portion is configured to accept an instruction as to whether to terminate the printing from the first user when the result of the colorimetry does not satisfy the criterion, and
the printing portion is configured to terminate the printing of the print image when an instruction of termination of the printing is accepted.
